(19) United States
(12) Patent Application Publication
(10) Pub. No.: US 2025/0260207 A1
(43) Pub. Date: Aug. 14, 2025

(54) CHARGING CONTACT WITH PRIMARY BRUSH MOTION ISOLATED FROM FLEXIBLE CONNECTION

(71) Applicant: Conductix, Inc., Omaha, NE (US)

(72) Inventor: Jonathon D. Smith, Kalamazoo, MI (US)

(21) Appl. No.: 19/048,067

(22) Filed: Feb. 7, 2025

Related U.S. Application Data
(60) Provisional application No. 63/551,742, filed on Feb. 9, 2024.

(51) Int. Cl. H01R 41/02; B60L 53/16

(52) U.S. Cl. CPC H01R 41/02; B60L 53/16

(57) ABSTRACT

A charging contact assembly can include a brush configured to translate in a first direction generally perpendicular to a second direction of travel of the charging contact assembly. The brush can include a first contact surface for contacting the conducting surface, and a second contact surface parallel to the first direction of translation of the brush and parallel to the second direction of travel of the charging contact assembly. The charging contact assembly can also include a connector having a flexible connection, and a connector contact surface electrically coupled with the flexible connection and arranged parallel to the second contact surface of the brush to slidingly contact the second contact surface of the brush. The charging contact assembly can further include a biasing mechanism for biasing the connector contact surface of the connector into contact with the second contact surface of the brush.

### CROSS-REFERENCE TO RELATED APPLICATIONS

The present application claims the benefit under 35 U.S.C. § 119 (e) of U.S. Provisional Application Ser. No. 63/551,742, filed Feb. 9, 2024, and titled “CHARGING CONTACT WITH PRIMARY BRUSH MOTION ISOLATED FROM FLEXIBLE CONNECTION,” which is herein incorporated by reference in its entirety.

### BACKGROUND

A charging contact is a contact-based electrical connector designed to connect a power source to mobile equipment through brush or plate contact. Charging contacts are equipped with a set of contact pins, plates, or surfaces configured to mate with a corresponding set of pins, plates, or surfaces on the equipment.

### DRAWINGS

The Detailed Description is described with reference to the accompanying figures. The use of the same reference numbers in different instances in the description and the figures may indicate similar or identical items.

FIG. 1 is an isometric view illustrating a charging contact assembly in accordance with an example embodiment of the present disclosure.

FIG. 2 is another isometric view of the charging contact assembly illustrated in FIG. 1.

FIG. 3 is an exploded isometric view of the charging contact assembly illustrated in FIG. 1.

FIG. 4 is another exploded isometric view of the charging contact assembly illustrated in FIG. 1.

FIG. 5 is a partial cross-sectional isometric view of the charging contact assembly illustrated in FIG. 1.

FIG. 6 is a partial cross-sectional end elevation view of the charging contact assembly illustrated in FIG. 1.

FIG. 7 is an isometric view illustrating a connector for a charging contact assembly, such as the charging contact assembly illustrated in FIG. 1, in accordance with an example embodiment of the present disclosure.

FIG. 8 is an isometric view illustrating another connector for a charging contact assembly, such as the charging contact assembly illustrated in FIG. 1, in accordance with an example embodiment of the present disclosure.

FIG. 9 is a side elevation view of the connector illustrated in FIG. 8.

FIG. 10 is an isometric view illustrating a further charging contact assembly in accordance with an example embodiment of the present disclosure.

FIG. 11 is another isometric view of the charging contact assembly illustrated in FIG. 10.

FIG. 12 is an exploded isometric view of the charging contact assembly illustrated in FIG. 10.

FIG. 13 is another exploded isometric view of the charging contact assembly illustrated in FIG. 10.

FIG. 14 is a partial cross-sectional isometric view of the charging contact assembly illustrated in FIG. 10.

FIG. 15 is a partial cross-sectional end elevation view of the charging contact assembly illustrated in FIG. 10.

FIG. 16 is a partial isometric view illustrating a housing for a charging contact assembly, such as the charging contact assembly illustrated in FIG. 10, in accordance with an example embodiment of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

A charging base can be used for charging a battery-powered vehicle such that the vehicle mounts the charging base to charge and then dismounts the charging base after charging its battery. For example, a charging base can be generally ramp-shaped, and a vehicle can have one or more contacts that are guided by the ramp shape of the charging base into contact with one or more battery charging contacts or charging brushes. The brushes can be connected to a power source, such as a supply of electrical energy. Generally, one or more charging brushes on a battery-powered vehicle are displaced (e.g., towards or away from the vehicle) when mounting and dismounting a charging base. Typically, a brush includes a shunt or wire, which can be molded into the brush, e.g., when the brush is manufactured. With this type of battery charging contact collector configuration, the brush and wire move up and down together with each cycle (e.g., as a vehicle drives onto and off of a charging base). This repeated motion fatigues the shunt with each cycle, eventually leading to shunt failure.

In general, it should be appreciated that the various embodiments of charging contact assemblies described herein may be arranged to deliver power to or receive power from a conducting surface. For example, in a first arrangement, a charging contact assembly is coupled with a power source, and a conducting surface is coupled with a battery-powered vehicle. In this arrangement, the charging contact assembly delivers power to the conducting surface while the charging contact assembly is in electrical communication with the conducting surface. In a second arrangement of power delivery from a power source to a battery-powered vehicle, a charging contact assembly is coupled with a battery-powered vehicle, and a conducting surface is coupled with a power source. In this arrangement, the charging contact assembly receives electrical power from the conducting surface while the charging contact assembly is in electrical communication with the conducting surface.

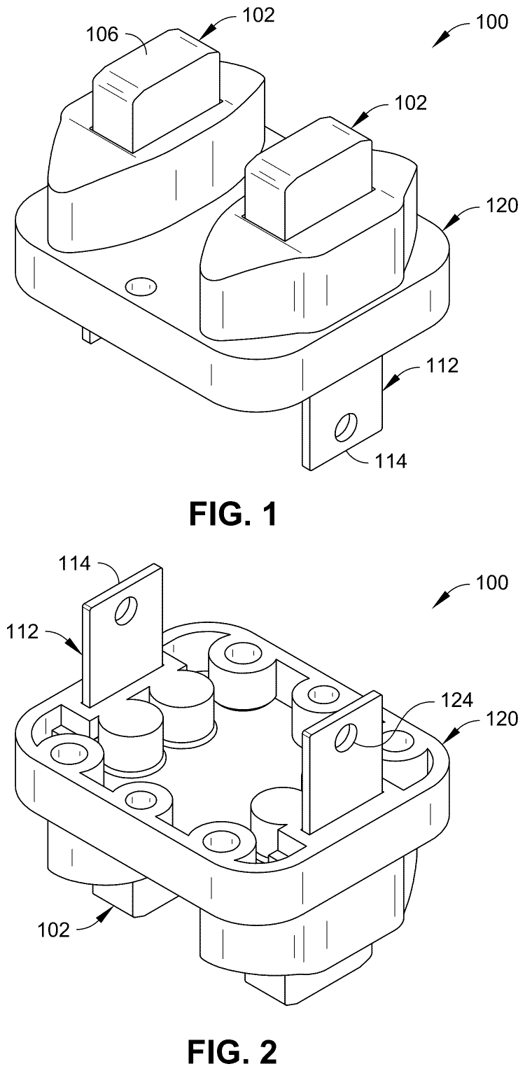

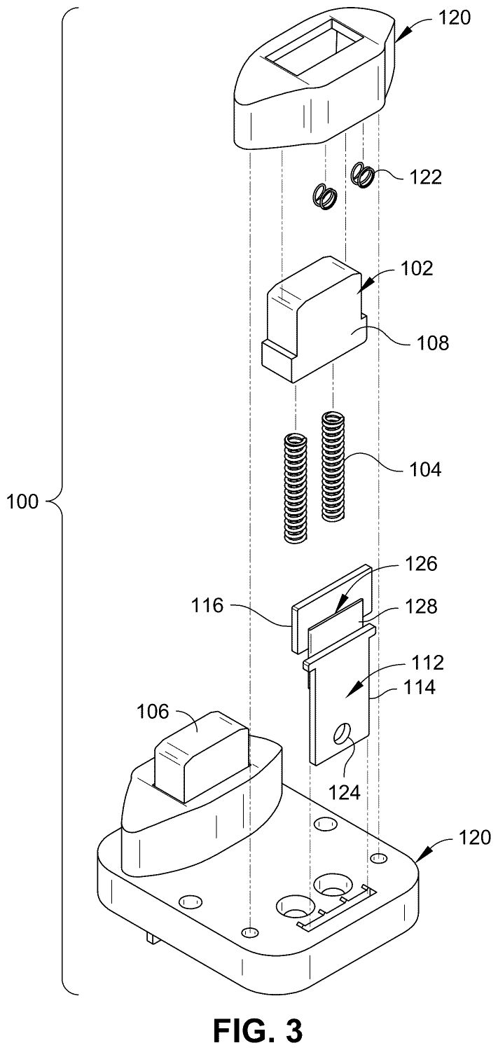

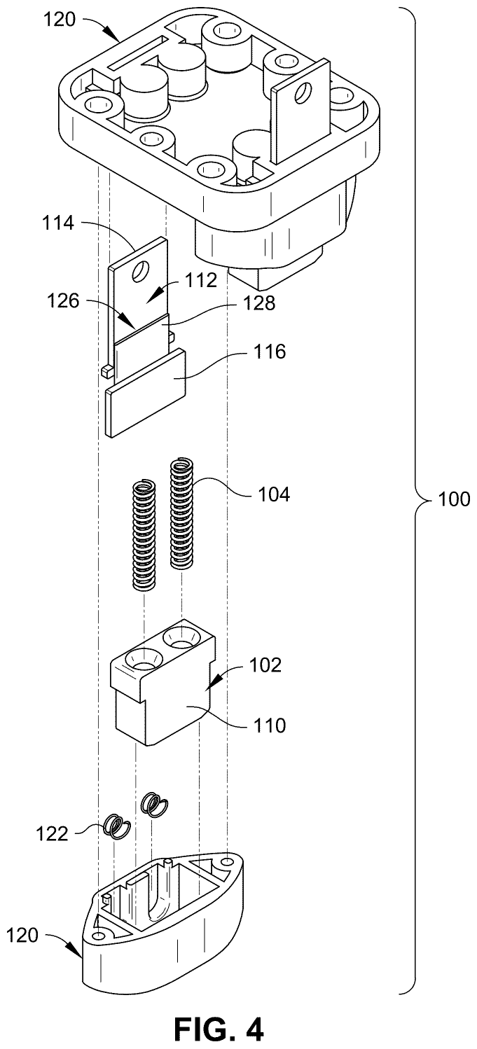

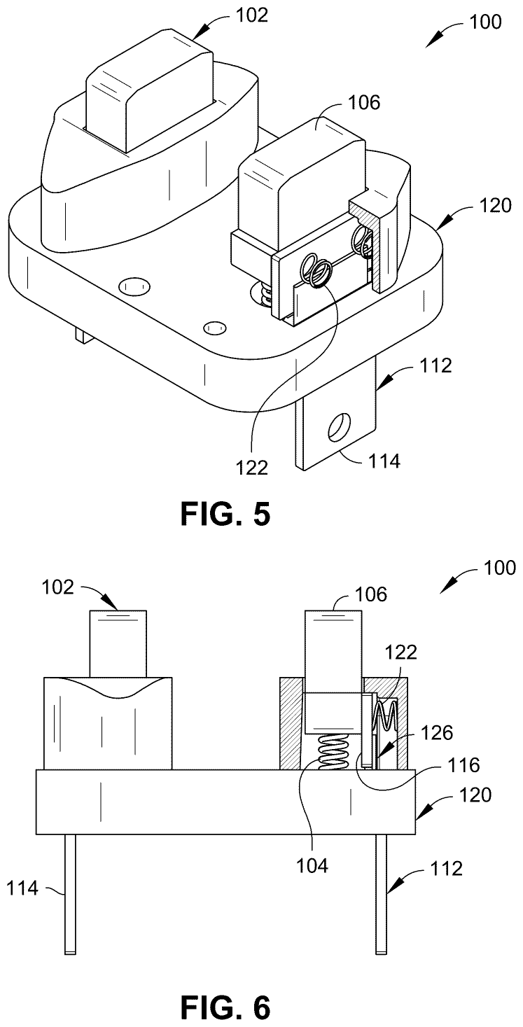

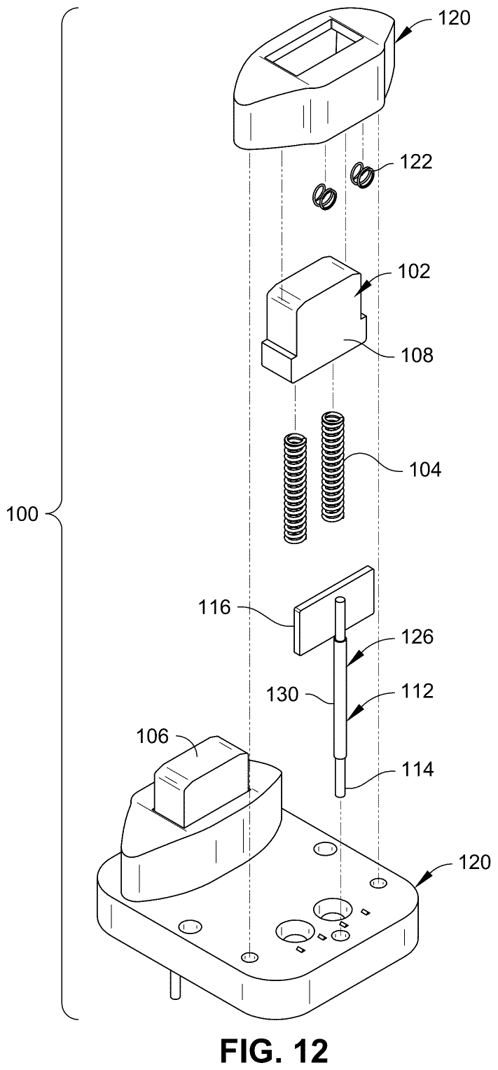

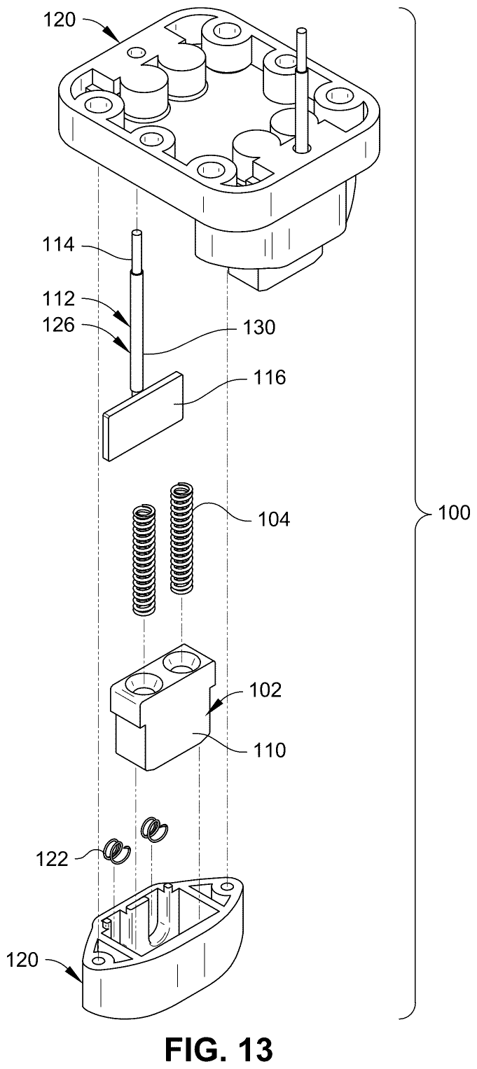

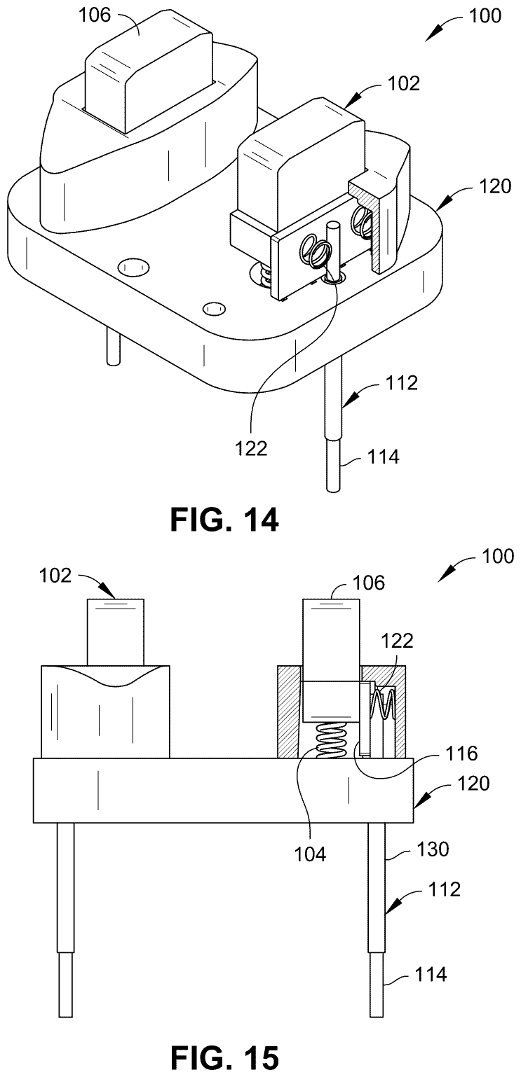

Referring now to FIGS. 1 through 16, charging contact assemblies 100 are described in accordance with example embodiments of the present disclosure. The charging contact assemblies 100 include one or more brushes and corresponding connectors where a connector includes a contact surface for contacting a brush, and a flexible connection allowing for some relative movement (e.g., deflection, rotation) between the plate that contacts the brush, and a connection to, for example, a vehicle. As described, the primary (e.g., vertical) motion of the brush is isolated from the flexible connection, reducing and/or minimizing strain on the flexible connection due to the limited vertical movement of the connection.

A charging contact assembly 100 includes a brush 102 for contacting a conducting surface to establish an electrical connection for carrying electrical current from a source of electrical energy through the conducting surface and the brush 102. In some embodiments, the brush 102 is made from a conducting material such as copper graphite. However, copper graphite is provided by way of example and is not meant to limit the present disclosure. A brush 102 can also be made from other conducting materials, such as a beryllium copper material. The conductive surface is configured to translate with respect to the charging contact assembly 100 (e.g., in a horizontal direction). As described, the brush 102 is configured to translate in another direction, i.e., generally perpendicular to the relative travel direction between the conductive surface and the charging contact assembly 100 (e.g., in a vertical direction). In some embodiments, the brush 102 can be biased in a direction toward the conducting surface, e.g., by one or more springs (e.g., coil springs 104) or other biasing members, including, but not necessarily limited to: compression springs, leaf springs, and so forth.

The brush 102 has a first contact surface 106 for contacting a conducting surface (e.g., the contact of a battery-powered vehicle, a conducting surface coupled with a power source, or another contact) to carry the electrical current through the conducting surface and the brush 102. The brush 102 also has a second contact surface 108 arranged along a plane generally parallel to the direction of translation of the brush 102 with respect to the conducting surface and generally parallel to the relative travel direction between the charging contact assembly 100 and the conducting surface. In some embodiments, the brush 102 may also have one or more additional contact surfaces. For example, the brush 102 can have a third contact surface 110 opposite from the second contact surface 108 and arranged along another plane generally parallel to the direction of translation of the brush 102 with respect to the conducting surface and generally parallel to the travel direction of the charging contact assembly 100 with respect to the conducting surface.

The charging contact assembly 100 also includes a connector 112 to connect to an electrical device (e.g., a power source, such as AC mains, a battery, etc.) for receiving or delivering electrical current and conducting the electrical current to and/or from the brush 102. For instance, the connector 112 includes one or more connections 114 for connecting to the source of electrical energy and one or more connector contact surface(s) 116 electrically coupled with the connection 114 and arranged generally parallel to the second contact surface 108 of the brush 102 to slidingly contact the second contact surface 108 of the brush 102. In embodiments of the disclosure, the second contact surface 108 (and possibly the third contact surface 110) of the brush 102 are smooth, conducting side surfaces, and the connector contact surface 116 (and possibly additional connector contact surface(s) of another connector for contacting the third contact surface 110) are conducting plates (e.g., copper plates) on either side of the brush 102.

The second contact surface 108 (and possibly the third contact surface 110) of the brush 102 slidingly contacts the connector contact surface(s) 116 (and possibly additional connector contact surface(s) in the case of the third contact surface 110) of the connector(s) 112 for carrying the electrical current through the connector(s) 112 and the brush 102. In some embodiments, motion of the brush 102 with respect to a connector 112 can be constrained by a housing 120 and/or one or more other support structures for controlling the motion of the brush 102 with respect to the connector 112. As described, the housing 120 can capture the connector contact surface 116 at four corners of the plate, aligning the connector contact surface 116 at the face of the plate with the second contact surface 108 of the brush 102. In some embodiments, the housing 120 can be used as the biasing mechanism, e.g., forcing the contact surface(s) of the brush 102 into contact with the connector contact surface(s) of the connector 112 (e.g., without the use of a spring).

In some embodiments, the charging contact assembly 100 can include one or more biasing mechanisms (e.g., one or more springs 122) for biasing the connector contact surface 116 (and possibly additional connector contact surface(s) in the case of the third contact surface 110) of the connector(s) 112 into contact with the second contact surface 108 (and possibly the third contact surface 110) of the brush 102. For example, one or more springs 122 are disposed between the connector contact surface(s) 116 and the housing 120 (e.g., within a brush holder or similar structure). In this manner, the connector contact surface 116 can be sprung towards the second contact surface 108 of the brush 102. Similarly, one or more springs can be disposed between additional connector contact surface(s) for the third contact surface 110 and the housing 120 (e.g., brush holder or similar structure). In this manner, the connector contact surface(s) can be biased (e.g., spring-loaded) to apply constant static pressure between the brush 102 and plates of the connector 112.

In some embodiments, a connection 114 can have a shunt (not shown) soldered thereto, providing continuity to an electrical device (e.g., a power source, such as AC mains, a battery, etc.). In some embodiments, a charging contact assembly 100 has a connection 114 that defines an aperture 124 for receiving a terminal fastener (not shown) or another fastening device. In this example, the terminal fastener can serve as a point of connection for a terminal shunt. The terminal shunt can have one or more terminals, including, but not necessarily limited to: a ring terminal, a spade terminal, or a lug terminal for providing electrical continuity to an electrical device. In some embodiments, the housing 120 can include one or more holes for receiving respective terminal fasteners. With the arrangement described herein, only the brush 102 moves with each cycle, while the shunt can remain static, which can reduce or eliminate fatigue on the shunt.

It should be noted that while charging contact assemblies have been described with some specificity, this arrangement is provided by way of example and is not meant to limit the present disclosure. In other embodiments, a brush 102 can be used with other various connectors and/or brush arrangements subject to vibration and/or shock loading. For example, in some embodiments, a brush 102 is included with a slip ring assembly. In this example, the brush 102 can be biased into physical contact with a ring rotatably coupled to a holder. In another example, a brush 102 is used as a motor brush assembly. In this example, the brush 102 can be biased into contact with a portion of the motor to conduct electrical energy between the rotating and stationary parts of the motor (e.g., by conducting electrical current from the connector, through the brush 102, and then to the rotor contacted by the brush). In a further example, a brush 102 is included with a compact collector or segmented collector shoe assembly, where multiple electrical collectors are movably positioned in a support block in a spaced-apart aligned manner. In this example, one or more brushes 102 can be connected to a common electrical bus bar attachment.

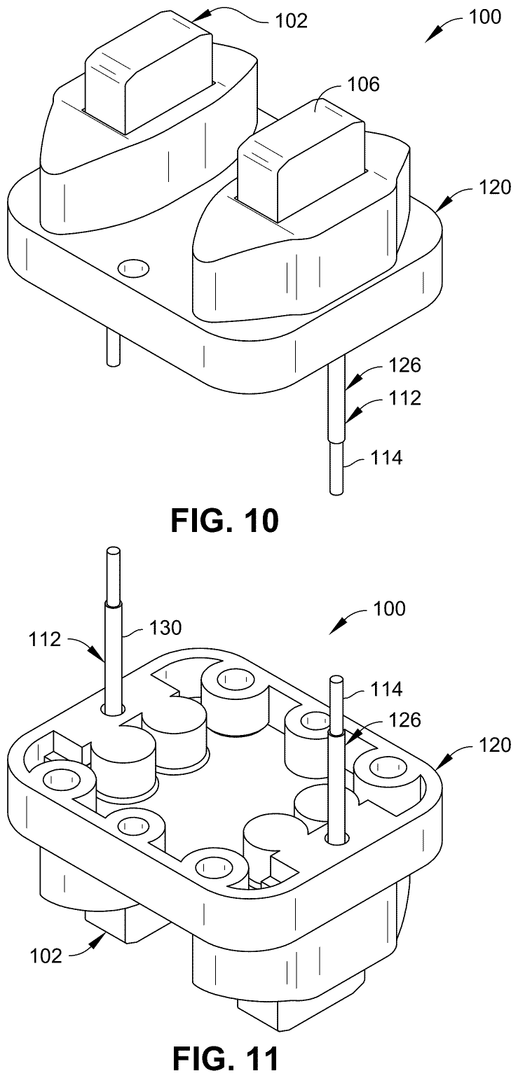

As described, the charging contact assemblies 100 each include a flexible connection 126 connected to the connector contact surface 116. For example, as described with reference to FIGS. 1 through 9, a braided shunt 128 can be affixed to the connector contact surface 116, e.g., by welding the braided shunt 128 to the plate. In another example, as described with reference to FIGS. 10 through 15, a wire 130 can be affixed to the connector contact surface 116. Example techniques for affixing a braided shunt 128 and/or a wire 130 to a connector contact surface 116 can include, but are not necessarily limited to: ultrasonic welding, resistance welding, soldering, and so forth. In some embodiments, the flexible connection (e.g., braided shunt 128) can also be affixed (e.g., welded, soldered, etc.) to a connection 114.

In some embodiments, the flexible connection 126 can be at least substantially flat in shape (e.g., having an elongated cross-sectional profile), with a substantially flat mesh conductor. In other embodiments, the flexible connection 126 is not necessarily flat (e.g., in the case of a braided, cylindrically shaped wire). In some embodiments, the flexible connection 126 can be formed of tinned copper braid. The tinned copper braid can be a tight weave of soft drawn tinned copper wire. The tinned copper braid may be constructed as a tube and then rolled flat to create a desired width. The flexible connection 126 can also be other braided materials (e.g., uncoated copper braid, braided aluminum), multi-stranded wire (e.g., a multi-strand circular conductor), and/or other conductive materials of various shapes. In some embodiments, a polymer material may be bonded and/or overmolded along a flexible connection 126.

As described, the flexible connection 126 allows for relative movement between the brush 102 and the connector 112 without placing undue stress on the flexible connection 126, such as would otherwise be experienced if a shunt or wire were molded into the brush. For example, the brush 102 may slide and/or rotate in direction(s) other than the vertical or generally perpendicular direction with respect to the relative travel direction between the conductive surface and the charging contact assembly 100. For instance, the brush 102 may be deflected with respect to the housing 120 in a horizontal or generally parallel direction with respect to the relative travel direction between the conductive surface and the charging contact assembly 100. In another example, the brush 102 may rotate with respect to the housing 120. The connector contact surface 116 captured at the four corners of the plate can remain aligned with the second contact surface 108 of the brush 102 via the flexibility of the flexible connection 126 to accommodate various motions of the connector contact surface 116. However, as described, the primary (e.g., vertical) motion of the brush 102 is still isolated from the flexible connection 126, limiting strain on the connector, e.g., as the flexible connection 126 is not flexed in the vertical direction due to its limited vertical movement.

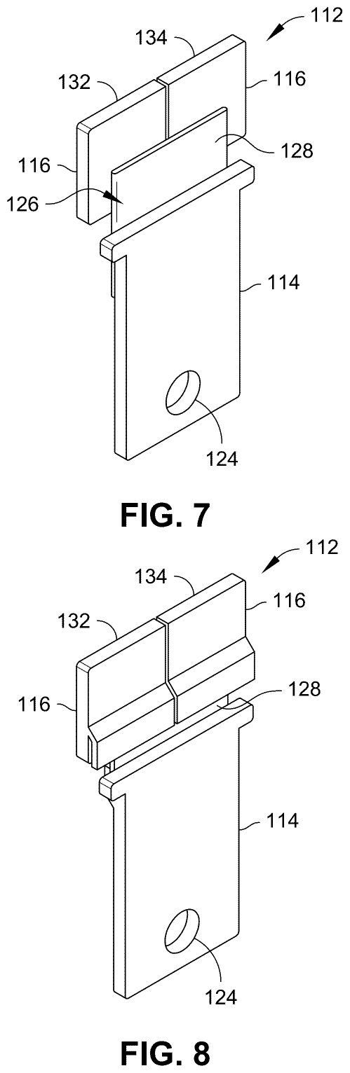

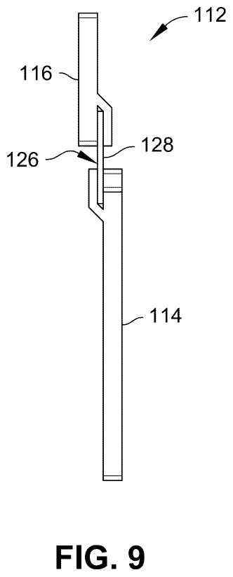

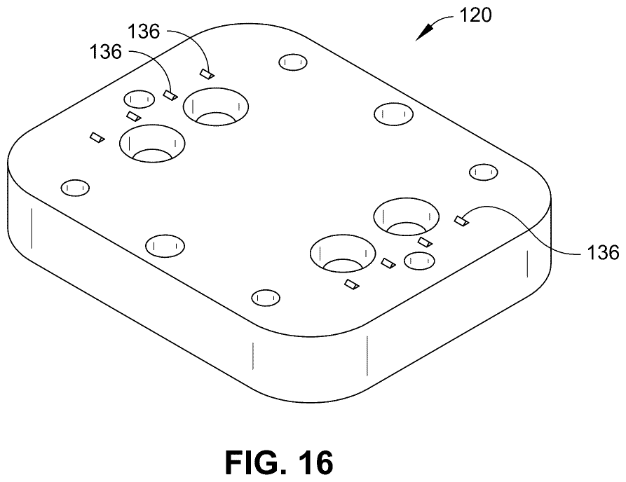

In some embodiments, the conducting plate of a connector contact surface 116 may be split or divided (e.g., physically separated) into multiple parallel plates and corresponding connector contact surfaces (e.g., two or more copper plates). For example, with reference to FIGS. 7 through 9, a connector contact surface 116 plate can be divided into a connector contact surface 132 and a separated connector contact surface 134, where each connector contact surface 132 and 134 is connected to the flexible connection 126, electrically linking the connector contact surface 132 and 134 together. Referring to FIGS. 8 and 9, in some embodiments the flexible connection 126 can be connected to a connector contact surface 116 and/or connector contact surfaces 132 and 134 (e.g., a single plate, multiple plates, etc.) via a swaged connection. For example, a braided shunt 128 can be connected to one or more molded copper plates via swaged braid connection(s). In some embodiments, a housing 120 can include one or more crush ribs 136, e.g., as shown in FIG. 16 to account for manufacturing tolerances where a brush holder is pressed against another part of the housing.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A charging contact assembly comprising:
a brush for contacting a conducting surface to carry an electrical current from a source of electrical energy through the conducting surface and the brush, the brush configured to translate in a first direction generally perpendicular to a second direction of travel of the conducting surface with respect to the charging contact assembly, the brush including:
a first contact surface for contacting the conducting surface, and
a second contact surface arranged along a plane generally parallel to the first direction of translation of the brush and generally parallel to the second direction of travel of the charging contact assembly with respect to the conducting surface;
a connector to connect to the brush for receiving the electrical current and conducting the electrical current, the connector including:
a flexible connection, and
a connector contact surface electrically coupled with the flexible connection and arranged generally parallel to the second contact surface of the brush to slidingly contact the second contact surface of the brush; and
a biasing mechanism for biasing the connector contact surface of the connector into contact with the second contact surface of the brush.

2. The charging contact assembly as recited in claim 1, wherein the flexible connection comprises a substantially flat flexible conductor.

3. The charging contact assembly as recited in claim 2, wherein the substantially flat flexible conductor is a braided conductor.

4. The charging contact assembly as recited in claim 1, wherein the connector contact surface electrically coupled with the flexible connection comprises a plate.

5. The charging contact assembly as recited in claim 4, wherein the plate is divided into at least a first connector contact surface and a second connector contact surface.

6. The charging contact assembly as recited in claim 1, wherein the flexible connection comprises a substantially circular flexible conductor.

7. The charging contact assembly as recited in claim 6, wherein the substantially circular flexible conductor comprises a multi-stranded wire.

8. The charging contact assembly as recited in claim 1, wherein the flexible connection is connected to the connector contact surface by a swaged connection.

9. A charging contact assembly comprising:
a brush for contacting a conducting surface to carry an electrical current from a source of electrical energy through the conducting surface and the brush, the brush configured to translate in a first direction different from a second direction of travel of the conducting surface with respect to the charging contact assembly, the brush including:
a first contact surface for contacting the conducting surface, and
a second contact surface arranged along a plane generally parallel to the first direction of translation of the brush; and
a connector to connect to the brush for receiving the electrical current and conducting the electrical current, the connector including:
a flexible connection, and
a connector contact surface electrically coupled with the flexible connection and arranged generally parallel to the second contact surface of the brush to slidingly contact the second contact surface of the brush.

10. The charging contact assembly as recited in claim 9, further comprising a biasing mechanism for biasing the connector contact surface of the connector into contact with the second contact surface of the brush.

11. The charging contact assembly as recited in claim 9, wherein the flexible connection comprises a substantially flat flexible conductor.

12. The charging contact assembly as recited in claim 11, wherein the substantially flat flexible conductor is a braided conductor.

13. The charging contact assembly as recited in claim 9, wherein the connector contact surface electrically coupled with the flexible connection comprises a plate.

14. The charging contact assembly as recited in claim 13, wherein the plate is divided into at least a first connector contact surface and a second connector contact surface.

15. The charging contact assembly as recited in claim 9, wherein the flexible connection comprises a substantially circular flexible conductor.

16. The charging contact assembly as recited in claim 15, wherein the substantially circular flexible conductor comprises a multi-stranded wire.

17. The charging contact assembly as recited in claim 9, wherein the flexible connection is connected to the connector contact surface by a swaged connection.

18. A charging contact assembly comprising:
a brush for contacting a conducting surface to carry an electrical current from a source of electrical energy through the conducting surface and the brush, the brush configured to translate in a first direction generally perpendicular to a second direction of travel of the conducting surface with respect to the charging contact assembly, the brush including:
a first contact surface for contacting the conducting surface, and
a second contact surface arranged along a plane generally parallel to the first direction of translation of the brush and generally parallel to the second direction of travel of the charging contact assembly with respect to the conducting surface;
a connector to connect to the brush for receiving the electrical current and conducting the electrical current, the connector including:
a flexible connection, and
a connector contact plate electrically coupled with the flexible connection and arranged generally parallel to the second contact surface of the brush to slidingly contact the second contact surface of the brush; and
a biasing mechanism for biasing the connector contact plate of the connector into contact with the second contact surface of the brush.

19. The charging contact assembly as recited in claim 18, wherein the connector contact plate is divided into at least a first connector contact surface and a second connector contact surface.

20. The charging contact assembly as recited in claim 18, wherein the flexible connection is connected to the connector contact surface by a swaged connection.
